(19) United States
(12) Patent Application Publication
(10) Pub. No.: US 2023/0221432 A1
(43) Pub. Date: Jul. 13, 2023

(54) SENSOR RECOGNITION INTEGRATION DEVICE

(71) Applicant: Hitachi Astemo, Ltd., Hitachinaka-shi, Ibaraki (JP)

(72) Inventors: Yuya TANAKA, Tokyo (JP); Katsuro WATANABE, Tokyo (JP)

(73) Assignee: Hitachi Astemo, Ltd., Hitachinaka-shi, Ibaraki (JP)

(21) Appl. No.: 18/008,848

(22) PCT Filed: Mar. 18, 2021
(86) PCT No.: PCT/JP2021/011102

§ 371 Date: Dec. 7, 2022

(30) Foreign Application Priority Data
Jun. 15, 2020 (JP) 2020-103101

(51) Int. Cl. G01S 13/931; B60W 50/00; G01S 13/86

(52) U.S. Cl. CPC G01S 13/931; B60W 50/0097; G01S 13/86; B60W 60/0027

(57) ABSTRACT

Provided is a sensor recognition integration device capable of reducing the load of integration processing so as to satisfy the minimum necessary accuracy required for vehicle travel control, and capable of improving processing performance of an ECU and suppressing an increase in cost. A sensor recognition integration device B006 that integrates a plurality of pieces of object information related to an object around an own vehicle detected by a plurality of external recognition sensors includes: a prediction update unit 100 that generates predicted object information obtained by predicting an action of the object; an association unit 101 that calculates a relationship between the predicted object information and the plurality of pieces of object information; an integration processing mode determination unit 102 that switches an integration processing mode for determining a method of integrating the plurality of pieces of object information on the basis of a positional relationship between a specific region (for example, a boundary portion) in an overlapping region of detection regions of the plurality of external recognition sensors and the predicted object information; and an integration target information generation unit 104 that integrates the plurality of pieces of object information associated with the predicted object information on the basis of the integration processing mode.

### TECHNICAL FIELD

The present invention relates to a sensor recognition integration device for processing integration of a plurality of pieces of object data (object information) from a plurality of sensors of different types with a low load, for example.

### BACKGROUND ART

In autonomous driving of an automobile, an object around the own vehicle is recognized, and driving is planned and determined according to the object. There are various sensors for detecting an object, such as a radar, a camera, a sonar, and a laser radar. Since these sensors have various conditions for a detection range, a detectable object, detection accuracy, cost, and the like, it is necessary to combine a plurality of sensors according to a purpose and integrate object information detected or acquired by each sensor. However, when the number of objects to be handled increases, it is necessary to improve the processing performance of an ECU depending on the processing cost of the integration, and thus, it is necessary to reduce the load of the integration processing. The “processing cost” refers to a processing time for the integration.

PTL 1 is a prior art document that reduces the load of processing of information from a plurality of sensors. The technique disclosed in FIG. 1 of PTL 1 includes: a first radar having a first detection range and performs calculation in a long calculation time; a second radar that has a second detection range overlapping the first detection range and performs calculation in a short calculation time; a first determination means that performs a presence determination of a target on the basis of a calculation result of the first radar; a second determination means that performs a presence determination of a target on the basis of a calculation result of the second radar; a presence confirmation means that confirms the presence of a target from a presence determination result of the first determination means; and a designation means that inputs a calculation result of the second radar to the second determination means and causes the second determination means to perform a current presence determination after confirmation of a previous target when the target whose presence has been confirmed by the presence confirmation means is present in an overlapping range of the first and second radars. In this target detection device, when the presence of the target is confirmed in the overlapping range of the first and second radars, the presence or absence of the next target can be confirmed even with low accuracy. Therefore, when the target whose presence has been confirmed by the presence confirmation means is present in the overlapping range, the designation means inputs the calculation result obtained by the second radar in the short calculation time to the second determination means, and causes the second determination means to determine the current presence after the confirmation of the previous target. Thus, the target can be detected at high speed. When the target enters the overlapping region with the first radar from the non-overlapping detection range of the second radar, the calculation amount can be reduced by narrowing the detection range by setting the focused detection range near the boundary between the overlapping range and the non-overlapping range.

### CITATION LIST

### Patent Literature

PTL 1: JP 2006-046962 A

### SUMMARY OF INVENTION

### Technical Problem

However, in PTL 1, it is assumed that the sensors are of the same type such as the radars, and when a target enters the overlapping region with the first radar from the non-overlapping detection range of the second radar, only the detection range is narrowed in the vicinity of the boundary between the overlapping range and the non-overlapping range, and for example, in a system configuration that handles a plurality of types of sensors, there is a problem that the load of integration processing cannot be reduced while maintaining the accuracy by utilizing the features of the plurality of types of sensors.

The present invention has been made in view of the above circumstances, and an object of the present invention is to provide a sensor recognition integration device capable of reducing the load of integration processing so as to satisfy the minimum necessary accuracy required for vehicle travel control, and capable of improving processing performance of an ECU and suppressing an increase in cost.

### Solution to Problem

In order to solve the above problem, a sensor recognition integration device according to the present invention is a sensor recognition integration device that integrates a plurality of pieces of object information related to an object around an own vehicle detected by a plurality of external recognition sensors, the sensor recognition integration device including: a prediction update unit that generates predicted object information obtained by predicting an action of the object on the basis of an action of the own vehicle estimated from a behavior of the own vehicle and the object information detected by the external recognition sensors; an association unit that calculates a relationship between the predicted object information and the plurality of pieces of object information; an integration processing mode determination unit that switches an integration processing mode for determining a method of integrating the plurality of pieces of object information on the basis of a positional relationship between a specific region in an overlapping region of detection regions of the plurality of external recognition sensors and the predicted object information; and an integration target information generation unit that integrates the plurality of pieces of object information associated with the predicted object information on the basis of the integration processing mode.

### Advantageous Effects of Invention

According to the present invention, it is possible to reduce the load of the integration processing so as to satisfy the minimum necessary accuracy required for the vehicle travel control according to the detection situation, and it is possible to obtain the effects of improving the processing performance of an ECU and suppressing an increase in cost.

Problems, configurations, and effects other than those described above will be clarified from the following description of embodiments.

### BRIEF DESCRIPTION OF DRAWINGS

FIG. 1 is a configuration diagram of an autonomous driving system including a sensor recognition integration device B006 according to a first embodiment of the present invention.

FIG. 2 is a sensor configuration example for a sensor object information integration unit B010 of the sensor recognition integration device B006 according to the first embodiment of the present invention.

FIG. 3 is a functional block diagram of the sensor object information integration unit B010 of the sensor recognition integration device B006 according to the first embodiment of the present invention.

FIG. 4 is a flowchart of an association unit 101 executed by the sensor object information integration unit B010 according to the first embodiment of the present invention.

FIG. 5 is a flowchart of an integration processing mode determination unit 102 executed by the sensor object information integration unit B010 according to the first embodiment of the present invention.

FIG. 6 is a flowchart of an integration target information generation unit 104 executed by the sensor object information integration unit B010 according to the first embodiment of the present invention.

FIG. 7 is a flowchart of a prediction update unit 100 executed by the sensor object information integration unit B010 according to the first embodiment of the present invention.

FIG. 8 is a flowchart of an integration update unit 105 executed by the sensor object information integration unit B010 according to the first embodiment of the present invention.

FIG. 9 is a diagram of an integration example (high-processing-load integration processing mode) in which components having a small error of each sensor are combined as integration processing of the integration target information generation unit 104 in FIG. 6.

FIG. 10 is a diagram of an integration example (low-processing-load integration processing mode) in which an object of each sensor is calculated by average processing as integration processing of the integration target information generation unit 104 in FIG. 6.

FIG. 11 is a diagram illustrating an example of using an overlapping region and a boundary portion of detection ranges as conditions of the integration processing mode determination unit 102 in FIG. 5.

FIG. 12 is a schematic diagram for calculating a distance between a target and the boundary portion of the overlapping region of the detection ranges in FIG. 11.

FIG. 13 is a configuration diagram of an autonomous driving system including a sensor recognition integration device B006 having a travel route estimation unit B012 according to a second embodiment of the present invention.

FIG. 14 is a diagram illustrating an example of using a travel route as a condition of the integration processing mode determination unit 102 in FIG. 5.

FIG. 15 is a diagram illustrating an example of using reliability as a condition of the integration processing mode determination unit 102 in FIG. 5.

FIG. 16 is a diagram illustrating a combination of a plurality of conditions of the integration processing mode determination unit 102.

FIG. 17 is a configuration diagram of an autonomous driving system including a sensor recognition integration device B006 having a planned path from an autonomous driving plan determination device B007 as input according to a fifth embodiment of the present invention.

FIG. 18 is a functional block diagram of a sensor object information integration unit B010 of a sensor recognition integration device B006 according to a seventh embodiment of the present invention.

### DESCRIPTION OF EMBODIMENTS

Hereinafter, embodiments of the present invention will be described in detail with reference to the drawings. In all the drawings for describing the embodiments of the invention, portions having the same functions are denoted by the same reference numerals, and repeated description thereof will be omitted.

### First Embodiment

### <Overall Configuration of Autonomous Driving System>

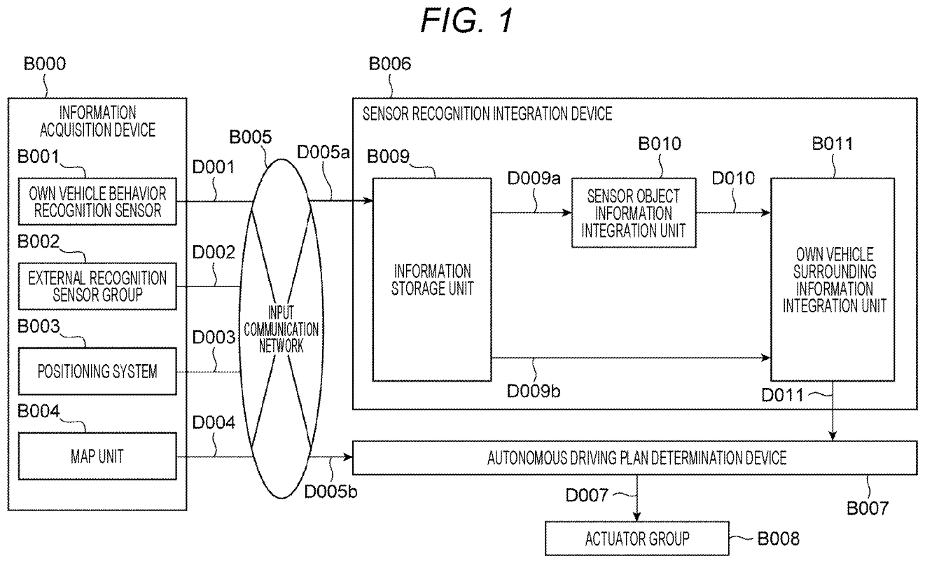

FIG. 1 is a configuration diagram of an autonomous driving system including a sensor recognition integration device B006 according to a first embodiment of the present invention. The autonomous driving system according to the present embodiment is a system that recognizes an object around an own vehicle (outside world) in a vehicle such as an automobile, and plans and determines driving according to the object, automatically performs vehicle travel control, or assists a driver's driving operation (steering).

### [Description of Configuration]

The autonomous driving system according to the present embodiment includes an information acquisition device B000, an input communication network B005, the sensor recognition integration device B006, an autonomous driving plan determination device B007, and an actuator group B008. The information acquisition device B000 includes an own vehicle behavior recognition sensor B001, an external recognition sensor group B002, a positioning system B003, and a map unit B004. The sensor recognition integration device B006 includes an information storage unit B009, a sensor object information integration unit B010, and an own vehicle surrounding information integration unit B011.

### [Description of Input and Output]

The own vehicle behavior recognition sensor B001 outputs recognized information D001 to the input communication network B005.

The external recognition sensor group B002 outputs recognized information D002 to the input communication network B005.

The positioning system B003 outputs positioned information D003 to the input communication network B005.

The map unit B004 outputs acquired information D004 to the input communication network B005.

D001, D002, D003, and D004 are input to the input communication network B005, and the input communication network B005 outputs information D005a flowing through the communication network to the sensor recognition integration device B006. D001 is input to the input communication network B005, and the input communication network B005 outputs information D005b flowing through the communication network to the autonomous driving plan determination device B007.

The sensor recognition integration device B006 receives the information D005a from the input communication network B005 as input, and outputs an integration result D011, which is vehicle surrounding information, to the autonomous driving plan determination device B007 as output information.

The autonomous driving plan determination device B007 receives the information D005b from the input communication network B005 and the integration result D011 from the sensor recognition integration device B006 as input, and outputs a plan determination result D007 as command information to the actuator group B008 as output information.

The information D005a from the input communication network B005 is input to the information storage unit B009, and the information storage unit B009 outputs stored information D009a to the sensor object information integration unit B010. The information storage unit B009 outputs stored information D009b to the own vehicle surrounding information integration unit B011.

The sensor object information integration unit B010 receives the information D009a from the information storage unit B009 as input, and outputs an integration result D010 that is integrated object information to the own vehicle surrounding information integration unit B011 as output information.

The own vehicle surrounding information integration unit B011 receives the information D009b from the information storage unit B009 as input, and outputs an integration result D011 that is vehicle surrounding information to the autonomous driving plan determination device B007 as output information.

### [Description of Data]

The own vehicle behavior recognition sensor B001 includes a gyro sensor, a wheel speed sensor, a steering angle sensor, an acceleration sensor, and the like mounted on the vehicle, and the recognized information D001 includes a yaw rate, a wheel speed, a steering angle, acceleration, and the like representing the behavior of the own vehicle.

The information D002 recognized from the external recognition sensor group B002 includes information (position information, speed information, and the like) obtained by detecting an object outside (around) the own vehicle, a white line of a road, a sign, and the like. As the external recognition sensor group B002, a combination of a plurality of external recognition sensors (hereinafter, simply referred to as a sensor) such as a radar, a camera, and a sonar is used. In addition, V2X and C2X may be included, and the configuration of the sensor is not particularly limited.

The positioned information D003 from the positioning system B003 includes a result of estimating the position of the own vehicle. An example of the positioning system B003 is a satellite positioning system.

The information D004 acquired from the map unit B004 includes map information around the own vehicle. In addition, the acquired information D004 may include route information in cooperation with navigation.

The information D005a from the input communication network B005 includes all or some of the information D001, D002, D003, and D004. Further, the information D005b includes at least the information D001. As the input communication network B005, a controller area network (CAN), Ethernet (registered trademark), wireless communication, or the like, which is a network generally used in in-vehicle systems, is used.

The output information D011 from the sensor recognition integration device B006 includes data obtained by integrating, as vehicle surrounding information, vehicle behavior information, sensor object information, sensor road information, positioning information, and map information from the input communication network B005.

The command information D007 from the autonomous driving plan determination device B007 includes information obtained by planning and determining how to move the own vehicle based on the information from the input communication network B005 and the own vehicle surrounding information from the sensor recognition integration device B006.

The actuator group B008 operates the vehicle in accordance with the command information D007 from the autonomous driving plan determination device B007. The actuator group B008 includes various actuators such as an accelerator device, a brake device, and a steering device mounted on the vehicle.

### [Description of Sub-Configuration]

The sensor recognition integration device B006 according to the present embodiment includes the information storage unit B009, the sensor object information integration unit B010, and the own vehicle surrounding information integration unit B011.

### [Description of Sub-Data]

The information storage unit B009 stores the information from the input communication network B005, and outputs information D009a in response to requests from the sensor object information integration unit B010 and the own vehicle surrounding information integration unit B011. The requests from the sensor object information integration unit B010 and the own vehicle surrounding information integration unit B011 include time synchronization of data of the information D002 from the plurality of sensors constituting the external recognition sensor group B002, standardization of a coordinate system, and the like. The sensor object information integration unit B010 acquires the information (sensor object information) D009a from the information storage unit B009, integrates information of the same object detected by the plurality of sensors constituting the external recognition sensor group B002 as the same object (to be described in detail later), and outputs the integrated object information D010 to the own vehicle surrounding information integration unit B011. Therefore, even when the positioning system B003 and the map unit B004 are not mounted, the integrated object information D010 can be output from the sensor object information integration unit B010, and the integrated object information D010 is output instead of the output information D011 of the own vehicle surrounding information integration unit B011, whereby the sensor object information integration unit B010 is established as a system. Therefore, even if the positioning system B003 and the map unit B004 are not necessarily mounted, the operation of the present embodiment is not hindered. The own vehicle surrounding information integration unit B011 acquires the integrated object information D010 from the sensor object information integration unit B010 and the information D009b (including the own vehicle behavior information, the sensor road information, the positioning information, and the map information) from the information storage unit B009, integrates them as the own vehicle surrounding information D011, and outputs them to the autonomous driving plan determination device B007. The own vehicle surrounding information D011 includes information indicating to which of a white line on a road and a lane on a map the integrated object information D010 from the sensor object information integration unit B010 belongs.

### <Attachment Configuration of External Recognition Sensor Group B002>

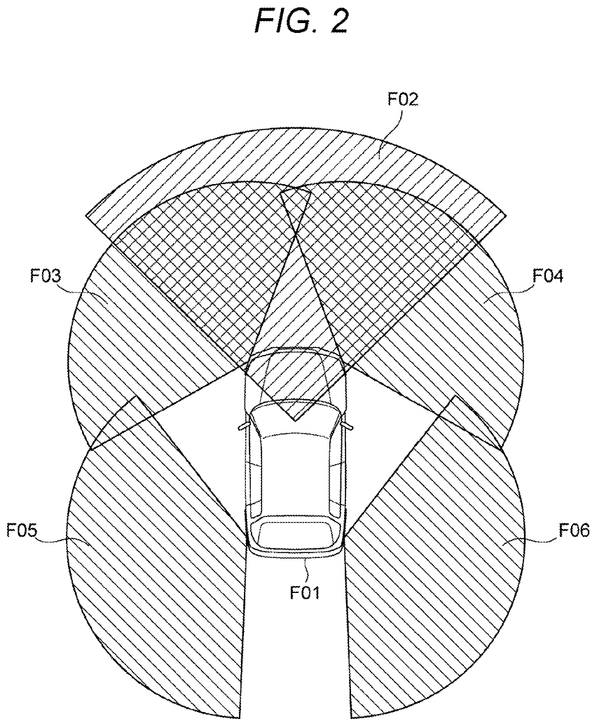

FIG. 2 is an attachment example of the external recognition sensor group B002 according to the first embodiment of the present invention. A camera sensor having a sensor detection range F02, a left front radar sensor having a sensor detection range F03, a right front radar sensor having a sensor detection range F04, a left rear radar sensor having a sensor detection range F05, and a right rear radar sensor having a sensor detection range F06 are arranged around the own vehicle F01, and the detection ranges of the respective sensors overlap (in other words, the sensors have overlapping regions of the detection regions). Note that the attachment configuration and the types of the sensors are not limited. From the viewpoint of redundancy and accuracy improvement, different types of sensor configurations are desirable.

### <Functional Block Configuration of Sensor Object Information Integration Unit B010 of Sensor Recognition Integration Device B006>

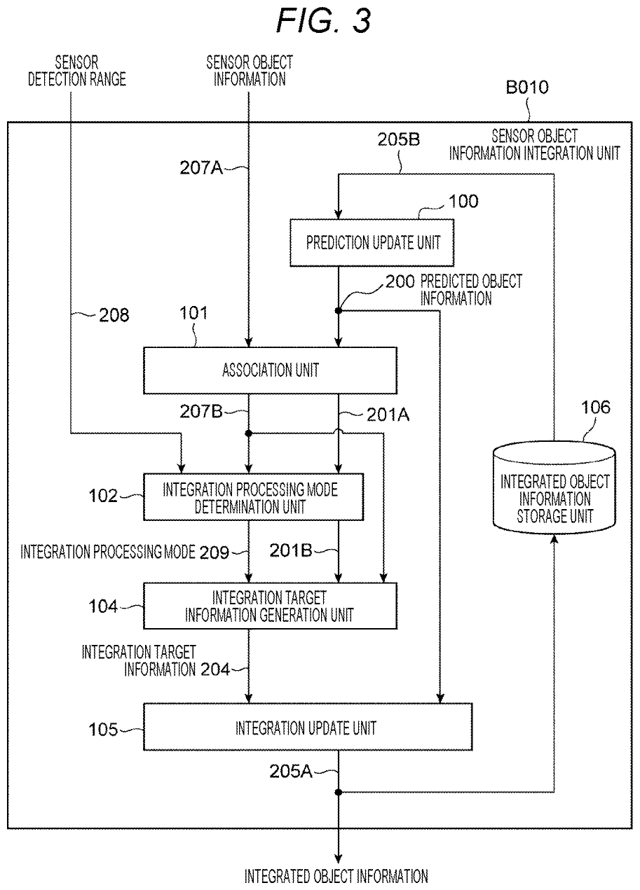

FIG. 3 is a functional block diagram of the sensor object information integration unit B010 of the sensor recognition integration device B006 according to the first embodiment of the present invention.

### [Description of Configuration]

The sensor object information integration unit B010 includes a prediction update unit 100, an association unit 101, an integration processing mode determination unit 102, an integration target information generation unit 104, an integration update unit 105, and an integrated object information storage unit 106. The processing of the sensor object information integration unit B010 is continuously repeatedly executed many times. In each execution, it is determined at which time information is to be estimated. For the sake of explanation, it is assumed that after the execution of the estimation of information at the time t₁, the estimation of information at the time t₂, which is the time after the time Δt, is executed.

### [Description of Data]

Sensor object information 207A and 207B has a sensor object ID assigned by tracking processing in the sensors constituting the external recognition sensor group B002, a relative position with respect to the own vehicle, a relative speed with respect to the own vehicle, and an error covariance. Information such as the object type, the detection time, and the reliability of the information may be additionally included.

An integration processing mode 209 has a mode for determining an integration method in the integration target information generation unit 104.

Predicted object information 200 and integrated object information 205A and 205B (synonymous with the integrated object information D010 in FIG. 1) have the time to estimate, an object ID, a relative position of an object, information of a relative speed of the object, an error covariance, or the equivalent. In addition, information such as the object type and the reliability of the information may be additionally included.

Integration target information 204 includes information on a sensor object after integration to be associated with the object ID of each object in the predicted object information 200. A position and speed of the sensor object information included in the integration target information 204 do not necessarily coincide with the original sensor object information 207A, and an integrated value utilizing the characteristics of the plurality of sensors constituting the external recognition sensor group B002 is calculated on the basis of the integration processing mode 209 of the integration processing mode determination unit 102.

Association information 201A and 201B has information indicating a correspondence between the predicted object information 200 and the plurality of pieces of sensor object information 207A and 207B.

As illustrated in FIG. 2, a sensor detection range (also referred to as a detection region) 208 has a horizontal field of view (FOV), an attachment angle, a maximum detection distance, and the like of each sensor constituting the external recognition sensor group B002.

### [Description of Flow]

### (Prediction Update Unit 100)

The prediction update unit 100 receives the integrated object information 205B at the time t₁ from the integrated object information storage unit 106, and generates and outputs the predicted object information 200 at the time t₂.

### (Association Unit 101)

The association unit 101 receives the plurality of pieces of sensor object information 207A from the external recognition sensor group B002 and the predicted object information 200 at the time t₂ from the prediction update unit 100 as input, and outputs the association information 201A indicating which predicted object information is associated with which of the plurality of pieces of sensor object information at the time t₂. Further, the sensor object information 207A is output as the sensor object information 207B without being changed. Note that the sensor object information 207A and 207B needs to be in the same time zone as the predicted object information 200 at the time t₂, and the sensor object information 207A and 207B is time-synchronized with the time t₂ in the information storage unit B009 in FIG. 1.

### (Integration Processing Mode Determination Unit 102)

The integration processing mode determination unit 102 calculates (switches) and outputs the integration processing mode 209 on the basis of the sensor object information 207B and the association information 201A from the association unit 101 and the sensor detection range 208 stored in advance in the information storage unit B009 in FIG. 1 or the like (to be described in detail later). In addition, the association information 201A is output as the association information 201B without being changed.

### (Integration Target Information Generation Unit 104)

The integration target information generation unit 104 receives the association information 201B at the time t₂ from the integration processing mode determination unit 102, the sensor object information 207B from the association unit 101, and the integration processing mode 209 from the integration processing mode determination unit 102 as input, and calculates an integrated value from coordinates and a speed of object information associated with each predicted object at the time t₂ and outputs the integrated value as the integration target information 204. At this time, a function of switching the integration method on the basis of the integration processing mode 209 from the integration processing mode determination unit 102 is included (described in detail later).

### (Integration Update Unit 105)

The integration update unit 105 receives the integration target information 204 from the integration target information generation unit 104 and the predicted object information 200 at the time t₂ from the prediction update unit 100, estimates a state (such as coordinates and a speed) of each object at the time t₂, and outputs the estimated state as the integrated object information 205A. Even when the integration method is switched by the integration target information generation unit 104, the integrated object information 205A may be generated inside the integration update unit 105 so that the position information and the speed information of the object do not change suddenly. In order to smoothly (continuously) change the integrated object information 205A, which is the object information after the integration, when the integration method (that is, the integration processing mode 209) is switched in the integration target information generation unit 104, when the position information or the speed information suddenly changes, a method of changing the position information or the speed information from the value before the change to the value after the change by linear interpolation can be considered. In addition, the change method may be not only linear interpolation but also spline interpolation.

### (Integrated Object Information Storage Unit 106)

The integrated object information storage unit 106 stores the integrated object information 205A from the integration update unit 105, and outputs the integrated object information 205A to the prediction update unit 100 as the integrated object information 205B.

### [Description of Flowchart]

### (Association Unit 101)

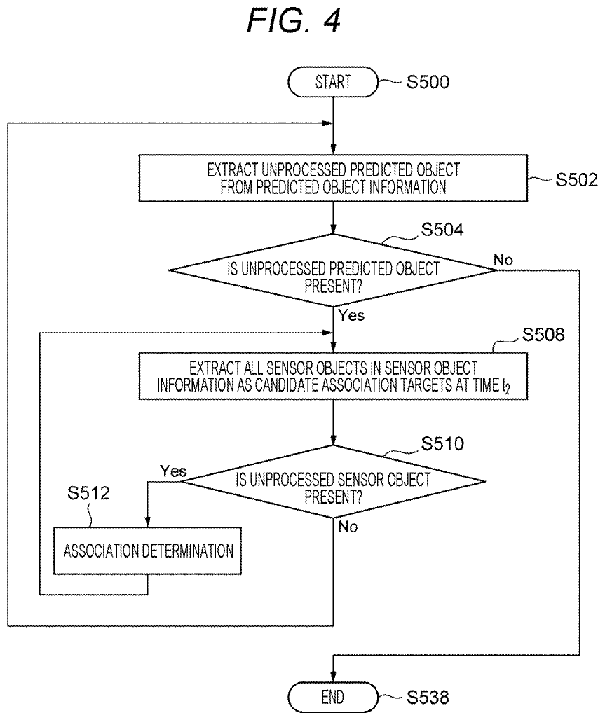

FIG. 4 is a flowchart of the association unit 101 executed by the sensor object information integration unit B010 according to the first embodiment of the present invention. Processing is started (S500). An unprocessed predicted object is extracted from the predicted object information 200 from the prediction update unit 100 (S502). In S504, when an unprocessed predicted object is present (S504: Yes), the processing proceeds to S508. Then, at the time t₂, all sensor objects in the sensor object information 207A as candidate association targets are extracted (S508). Alternatively, it is also possible to extract a set including at least all association targets by a method such as indexing. Next, when an unprocessed sensor object is present among the sensor objects as the candidate association targets in S510 (S510: Yes), association determination (S512) is performed on the unprocessed sensor object in S512, and the processing returns to S508. In S510, when an unprocessed sensor object is not present (S510: No), the processing returns to S502. In S504, when an unprocessed predicted object is not present (S504: No), the processing ends (S538).

In the association determination (S512), it is determined whether a distance between the predicted object information 200 from the prediction update unit 100 and position information, speed information, and the like of the sensor object included in the plurality of pieces of sensor object information 207A from the external recognition sensor group B002 is short, and it is determined whether to perform association. Further, the result is output as association information 201A. As the distance to be obtained at this time, the Mahalanobis distance may be used on the basis of the distance in the Euclidean space of the coordinates and speed of each sensor, the coordinates and speed of each sensor, and the error covariance. Note that the Mahalanobis distance is a generally defined distance, and description thereof is omitted in the present embodiment.

### (Integration Processing Mode Determination Unit 102)

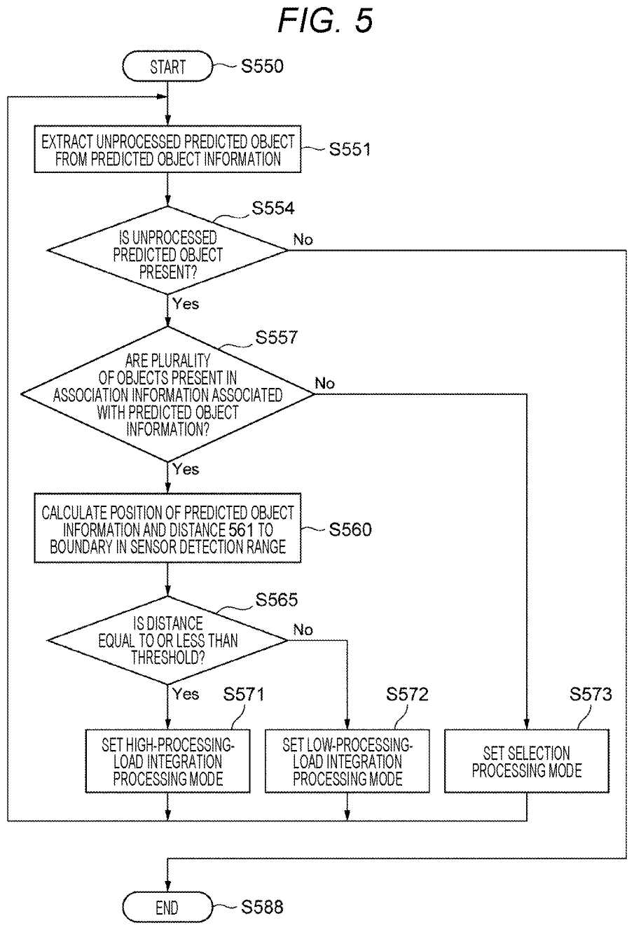

FIG. 5 is a flowchart of the integration processing mode determination unit 102 executed by the sensor object information integration unit B010 according to the first embodiment of the present invention. Processing is started (S550) and proceeds to S551. In S551, an unprocessed predicted object is extracted from the predicted object information 200 from the prediction update unit 100. In S554, when an unprocessed predicted object is present (S554: Yes), the processing proceeds to S557. In S557, when a plurality of sensor objects are present in the association information 201A associated with the predicted object information 200 calculated by the association unit 101 (S557: Yes), the processing proceeds to S560. In S560, the position information of the predicted object information 200 and a distance 561 to a boundary in the sensor detection range 208 stored in advance in the information storage unit B009 or the like in FIG. 1 are calculated, and the processing proceeds to S565. When the calculated distance 561 is equal to or less than a threshold in S565 (S565: Yes), a high-processing-load integration processing mode (hereinafter, also referred to as a high processing load mode) is set (S571). When the calculated distance 561 is not equal to or less than the threshold in S565 (S565: No), a low-processing-load integration processing mode (hereinafter, also referred to as a low processing load mode) is set (S572). Note that, for example, the high processing load mode indicates a mode for obtaining a calculation result regarding the position and speed of the object in relatively detail. In addition, the low processing load mode indicates a mode for obtaining a calculation result regarding the position and speed of the object in a relatively simple manner. When only a single sensor object is present in the association information 201A in S557 (S557: No), a selection processing mode is set (S573). Further, the setting results of S571, S572, and S573 are output as the integration processing mode 209.

After the setting in S571, S572, and S573, the processing returns to S551. Then, the processing is repeated until an unprocessed predicted object is not present in S554, and when an unprocessed predicted object is not present (S554: No), the processing of the integration processing mode determination unit 102 ends in S588.

Note that the selection processing mode (S573) means that object information of a single sensor is adopted. The selection processing mode (S573) may be performed in the low-processing-load integration processing mode (S572).

Here, the reason why the integration processing mode 209 (high-processing-load integration processing mode, low-processing-load integration processing mode) is set (switched) using the position information of the predicted object information 200 and the distance 561 to the boundary in the overlapping region of the sensor detection range 208 as a determination criterion is that the detection error of the sensor varies between the boundary in the overlapping region of the sensor detection range 208 and the region other than the boundary, specifically, the detection error of the sensor at the boundary in the overlapping region of the sensor detection range 208 tends to be relatively large.

### (Integration Target Information Generation Unit 104)

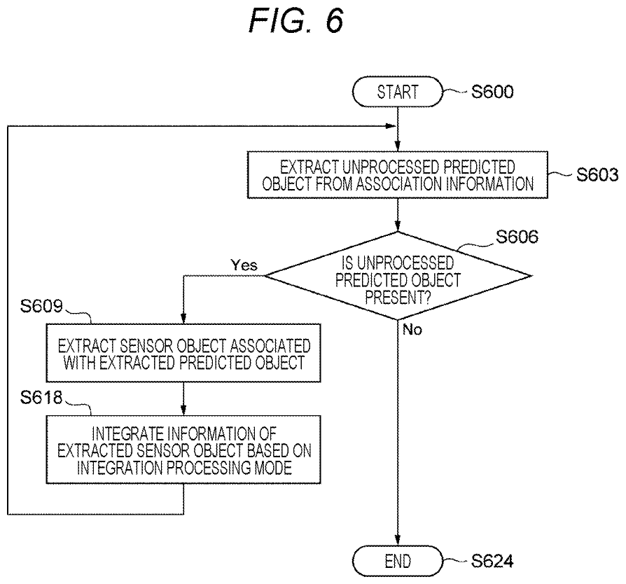

FIG. 6 is a flowchart of the integration target information generation unit 104 executed by the sensor object information integration unit B010 according to the first embodiment of the present invention. The processing of the integration target information generation unit 104 is started in S600, and proceeds to S603. In S603, an unprocessed predicted object is extracted from the association information 201B from the integration processing mode determination unit 102, and the processing proceeds to S606. When an unprocessed predicted object is present in S606 (S606: Yes), the processing proceeds to S609. A sensor object associated with the extracted predicted object is extracted in S609, and information of the extracted sensor object is integrated based on the integration processing mode 209 calculated by the integration processing mode determination unit 102 in S618 (described later). The integration result is output as the integration target information 204. Then, the processing returns to S603. When an unprocessed predicted object is not present in S606 (S606: No), the integration target information generation ends in S624.

For an object from a sensor that is not associated with any predicted object, the association determination may be performed between objects of each sensor as illustrated in FIG. 4, the integration processing mode in FIG. 5 may be determined, and the integration may be similarly performed in FIG. 6.

### (Prediction Update Unit 100)

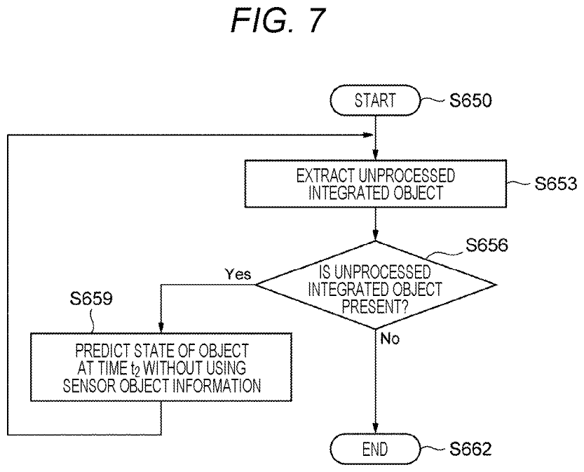

FIG. 7 is a flowchart of the prediction update unit 100 executed by the sensor object information integration unit B010 according to the first embodiment of the present invention. In S650, the processing of the prediction update unit 100 is started, and proceeds to S653. In S653, an unprocessed integrated object is extracted based on the integrated object information 205B from the integrated object information storage unit 106, and the processing proceeds to S656. In S656, when an unprocessed integrated object is present (S656: Yes), the processing proceeds to S659, and when an unprocessed integrated object is not present (S656: No), the processing proceeds to S662. In S659, the state of the object at the time t₂ is predicted without using the sensor object information from the external recognition sensor group B002, the prediction result is output as the predicted object information 200, and the processing returns to S653. In S662, the processing of the prediction update unit 100 ends. In the prediction in S659, it is assumed that the prediction is performed based on the behavior of the own vehicle and the behavior of the object. The action of the own vehicle is estimated based on a speed, a yaw rate, or the like of the own vehicle. In addition, the action of the object is estimated based on a speed, a yaw rate, or the like of the object.

### (Integration Update Unit 105)

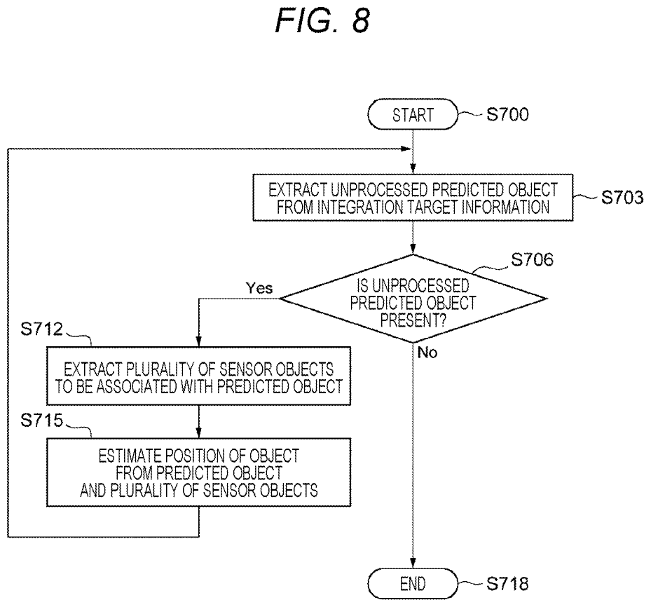

FIG. 8 is a flowchart of the integration update unit 105 executed by the sensor object information integration unit B010 according to the first embodiment of the present invention. The processing of the integration update unit 105 is started in S700, and proceeds to S703. In S703, an unprocessed predicted object is extracted from the integration target information 204 from the integration target information generation unit 104, and the processing proceeds to S706. In S706, when an unprocessed predicted object is present (S706: Yes), the processing proceeds to S712, and when an unprocessed predicted object is not present (S706: No), the processing proceeds to S718. In S712, a plurality of sensor objects to be associated with the predicted object are extracted, and the processing proceeds to S715. In S715, the position of the object is estimated from the predicted object from the prediction update unit 100 and the plurality of sensor objects, and the estimation result is output as the integrated object information 205A, and the processing returns to S703. The sensor objects in S715 refer to objects after integration. In step S718, the processing of the integration update unit 105 ends.

### [Additional Description of Integration Processing Mode]

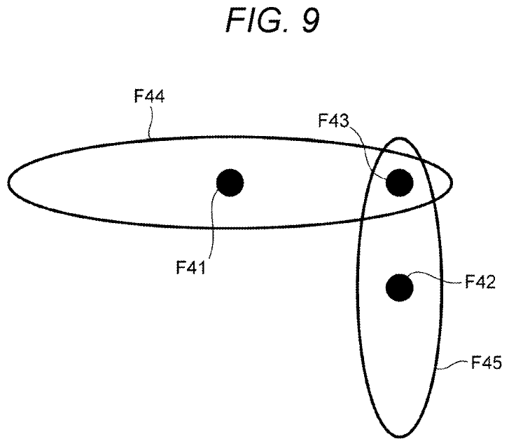

As an example of the high-processing-load integration processing mode in the integration processing mode determination unit 102, in other words, as an example of the high-processing-load integration processing mode used in the integration processing of the integration target information generation unit 104, there is an integration method illustrated in FIG. 9. FIG. 9 illustrates an example in which the traveling direction of the own vehicle is upward.

In FIG. 9, F41 represents a position where an object is detected by the radar, and F44 represents an error covariance. Since the error of the radar as the external recognition sensor depends on the angular resolution, the error spreads in the lateral direction with respect to the attachment direction of the sensors. Further, F42 in FIG. 9 represents a position where an object is detected by the camera, and F45 represents an error covariance. The error covariance of the object by the camera as the external recognition sensor spreads in the vertical direction with respect to the attachment direction of the sensors depending on the size of the pixel pitch or the like. In the case of handling sensors having different principles as described above, it is conceivable that the spreads of errors (error distributions) are different. In the high-processing-load integration processing mode, it is possible to improve the positional accuracy of the object by taking a component with a small error of each sensor and calculating an integration result F43 on the basis of the high-processing-load integration processing mode in the integration target information generation unit 104. This processing requires inverse matrix operation of the error covariance matrix, and is high-processing-load (detailed) integration processing.

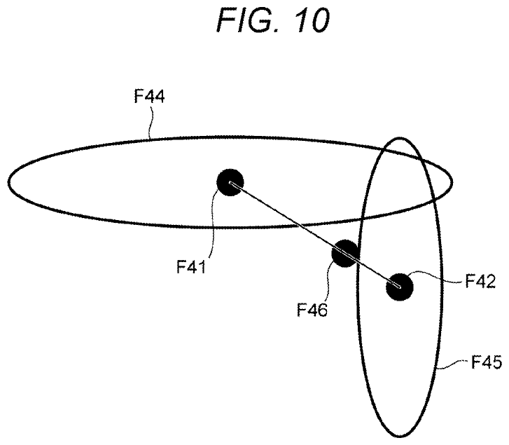

As an example of the high-processing-load integration processing mode in the integration processing mode determination unit 102, in other words, as an example of the high-processing-load integration processing mode used in the integration processing of the integration target information generation unit 104, there is an integration method illustrated in FIG. 10.

Similarly to FIG. 9, F41 in FIG. 10 represents a position where an object is detected by the radar, and F44 represents an error covariance. Further, F42 in FIG. 10 represents a position where an object is detected by the camera, and F45 represents an error covariance. F46 in FIG. 10 represents an integration result based on the low-processing-load integration processing mode, where the low-processing-load integration processing mode is a method of averaging positions of objects of each sensor. This processing is integration processing with simple calculation and a low processing load. Note that the average may be a weighted average, or a weight parameter may be calculated from the error covariance. It is desirable to set the weight from sensor-specific information so that the characteristics of the sensors can be considered even with a low processing load. In addition, as integration processing with a low processing load, when an object detected by a plurality of sensors is present, information of one of the sensors may be selectively used. Note that the method of adopting information of one of the sensors and the selection processing mode (S573) in FIG. 5 have the same meaning.

### [Additional Description of Calculation of Distance to Boundary]

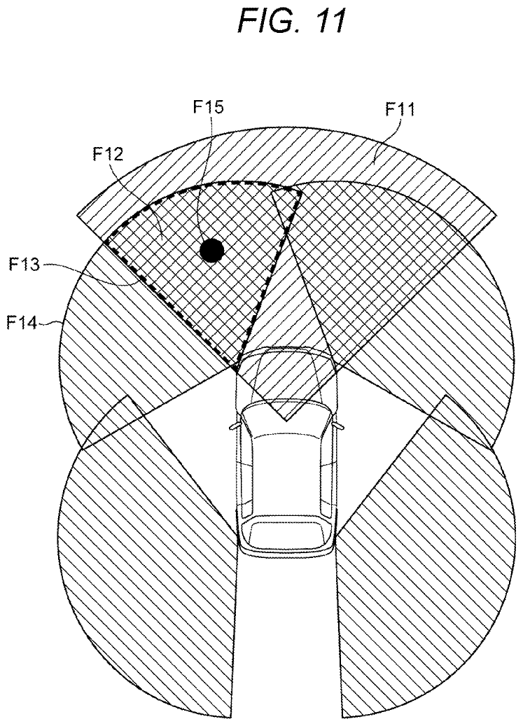

The method for calculating the position information of the predicted object information 200 and the distance 561 to the boundary in the sensor detection range 208 in S560 of FIG. 5 will be supplemented. In FIG. 11, predicted object information F15 belongs to the sensor detection range. F11 and F14 represent detection ranges of a single sensor (for example, a camera or a radar), and F12 and F13 represent a region where detection ranges of a plurality of sensors (for example, cameras and radars) overlap. A dotted line of F13 represents a boundary portion of the overlapping region, and F12 represents a non-boundary portion of the overlapping region.

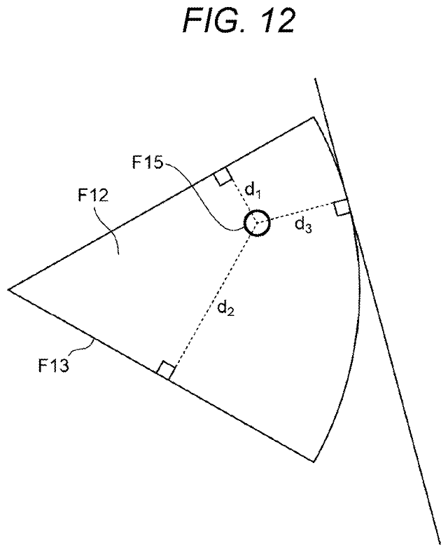

In the integration target information generation unit 104, the region in which the sensor detection ranges overlap is a target, and predicted object information F15 positioned at F12 and F13 is to be integrated. Note that a plurality of objects from the sensor are associated with the predicted object information F15 by the association unit 101, and a plurality of objects from the sensor to be associated are obtained. The plurality of objects from the sensor are to be integrated. First, in order to determine whether the predicted object information F15 belongs to F12 or F13, the distance between the boundary portion of F13 and the position of the predicted object information F15 is calculated. As a simple method, as illustrated in FIG. 12, a perpendicular line is drawn from the position of the predicted update information F15 to the boundary portion of F13, and a distance d=min(d₁, d₂, d₃) from the closest side is set to a distance 561 (d₁ in the example illustrated in FIG. 12) to the boundary portion. When the shape of the boundary portion is complex, a polygon polygon may be defined, and the distance may be calculated for each side. In the determination as to whether the distance in S565 in FIG. 5 is equal to or less than the threshold, the threshold may be set in view of a margin from the boundary portion. In addition, the threshold may be changed for each sensor, or the threshold may be variable.

In addition to the condition of FIG. 5, when the distance from the own vehicle to the object (also referred to as a target) is equal to or more than the threshold, the high-processing-load integration processing mode may be set, and when the distance from the own vehicle to the object (target) is less than the threshold, the low-processing-load mode may be set. This is because the detection error of the sensor tends to increase as the distance from the own vehicle to the object increases, and thus, it is preferable to set the high processing load mode in which a component having a small error of the sensor is taken and the accuracy of the integration result is improved.

### [Description of Effects]

As described above, the present embodiment is the sensor recognition integration device B006 that integrates a plurality of pieces of object information (sensor object information) related to an object around an own vehicle detected by a plurality of external recognition sensors, the sensor recognition integration device B006 including: the prediction update unit 100 that generates predicted object information obtained by predicting an action of the object on the basis of an action of the own vehicle estimated from a behavior of the own vehicle and the object information detected by the external recognition sensors; the association unit 101 that calculates a relationship (association information) between the predicted object information and the plurality of pieces of object information; the integration processing mode determination unit 102 that switches an integration processing mode (a high-processing-load integration processing mode in which processing of integrating the plurality of pieces of object information is relatively detailed processing, and a low-processing-load integration processing mode in which processing of integrating the plurality of pieces of object information is relatively simple processing) for determining a method of integrating the plurality of pieces of object information on the basis of a positional relationship between a specific region (for example, a boundary portion) in an overlapping region of detection regions of the plurality of external recognition sensors and the predicted object information; and, the integration target information generation unit 104 that integrates the plurality of pieces of object information related to (corresponding to) the predicted object information on the basis of the integration processing mode.

According to the present embodiment, for example, the integration processing with a high processing load is allocated to the boundary portion in the overlapping region of the sensors, and the integration processing with a low processing load is performed other than that, so that the ratio of the integration processing with a high processing load as a whole is minimized, and the effect of reducing the processing load can be expected. In addition, regardless of the high-processing-load integration processing or the low-processing-load integration processing, the integration target information generation unit 104 in consideration of the error covariance (error distribution) of the object takes components with small errors of the plurality of sensors, and the accuracy as a system can be improved.

According to the present embodiment, it is possible to reduce the load of the integration processing so as to satisfy the minimum necessary accuracy required for the vehicle travel control according to the detection situation, and it is possible to obtain the effects of improving the processing performance of an ECU and suppressing an increase in cost.

### Second Embodiment

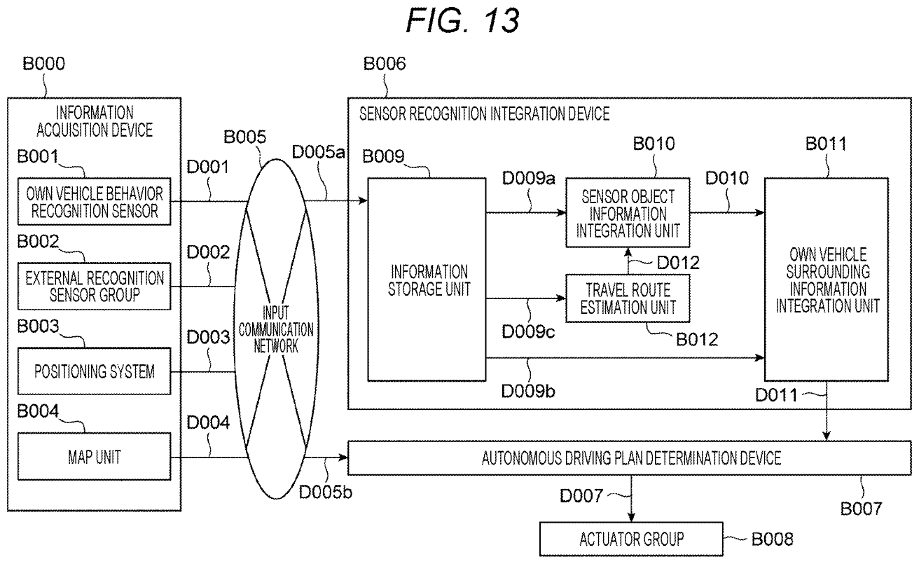

In the second embodiment, as in the first embodiment, the functional block diagram of FIG. 3 and the flowcharts of FIGS. 4 to 8 are adopted. However, the autonomous driving system configuration of FIG. 1 and the determination condition of the integration processing mode determination unit 102 illustrated in FIG. 5 are different from those of the first embodiment. FIG. 13 is a configuration diagram of an autonomous driving system including a sensor recognition integration device B006 according to a second embodiment of the present invention.

In FIG. 13, a sub-configuration is added to the autonomous driving system configuration of FIG. 1. As for additional portions, a travel route estimation unit B012 is added to the sensor recognition integration device B006, and information (data) D009c is output from the information storage unit B009 to the travel route estimation unit B012. The travel route estimation unit B012 outputs the travel route estimation result D012 to a sensor object information integration unit B010.

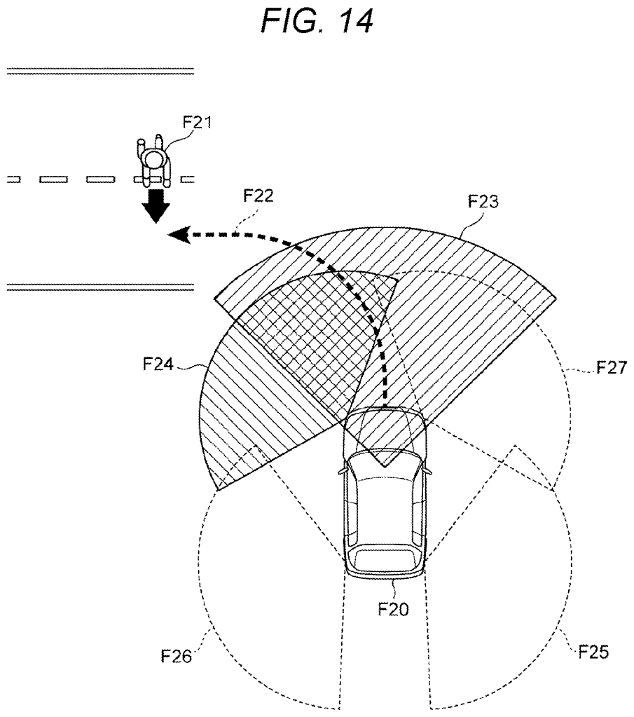

The travel route estimation unit B012 estimates a travel route F22 (see FIG. 14) of an own vehicle F20 based on the data D009c from the information storage unit B009. Note that the travel route of the own vehicle represents a traveling path of the own vehicle, and may indicate a speed or a yaw rate of the own vehicle on the path as additional information. The data D009c represents information (for example, the information is acquired by the own vehicle behavior recognition sensor B001 and stored in the information storage unit B009) such as an own vehicle speed, a yaw rate, and a steering angle, and the travel route estimation unit B012 calculates (estimates) a traveling path of the own vehicle in the future based on the information. Specifically, the turning radius of the own vehicle is estimated based on the state of the steering angle and the yaw rate. When and at which position the own vehicle is present is predicted based on the turning radius, and the prediction result is output to the sensor object information integration unit B010 as a travel route estimation result D012.

A scene illustrated in FIG. 14 is a scene where the own vehicle F20 turns left at an intersection in a situation where a pedestrian F21 is crossing a road. In FIG. 14, the predicted position of the travel route F22 (calculated by the travel route estimation unit B012) estimated from the vehicle speed and the yaw rate is located on the sensor detection ranges F23 and F24. In this case, an object having high relevance to the travel route F22 on which the own vehicle F20 travels is prioritized, the high processing load mode is set only in the overlapping portion of the sensor detection ranges of F23 and F24 located on the travel route F22 of the own vehicle F20, and the mode is switched to the low processing load mode for the other sensor detection ranges F25, F26, and F27. The condition may be combined with the condition based on the boundary portion of (the overlapping region of) the sensor detection ranges in FIG. 5 described in the first embodiment.

By adopting the travel route F22 of the second embodiment, in addition to the effects of the first embodiment, the ratio of the integration processing with a high processing load can be further minimized, and the effect of reducing the processing load is improved. Since the travel route on which the own vehicle travels is emphasized, the pedestrian F21 that is likely to require an alarm or a brake is preferentially processed. In addition, in a case where a bicycle or a motorcycle passing on the left of the own vehicle is present, a sensor detection range F26 illustrated in FIG. 14 also has a high priority. Therefore, it is necessary to switch the condition for the high processing load mode depending on the scene. For example, assuming that the travel route F22 is directed to the left side, a method of increasing the priority of the sensors mounted on the left side of the own vehicle F20 can be considered. In addition, as another way of thinking, the predicted position of the object may be estimated, the high processing load mode may be applied to an object that has a possibility of crossing the travel route F22 and moves at a high relative speed (that is, an object having a high effect on the travel route F22), and the low processing load mode may be applied to other objects that have a low possibility of crossing (that is, objects having a low effect on the travel route F22).

### Third Embodiment

In the third embodiment, as in the first embodiment, the autonomous driving system configuration of FIG. 1, the functional block diagram of FIG. 3, and the flowcharts of FIGS. 4 to 8 are adopted. However, the determination condition of the integration processing mode determination unit 102 of FIG. 5 is different from that of the first embodiment.

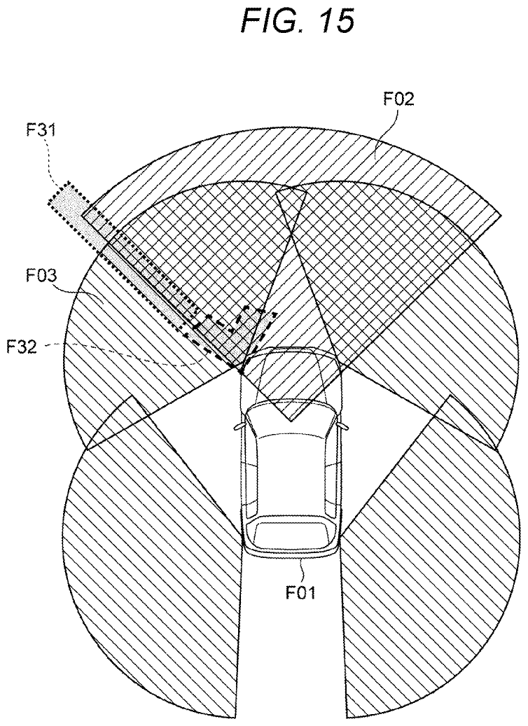

F31 and F32 illustrated in FIG. 15 are examples of regions where the reliability decreases in the sensor detection range. F31 represents a region where the reliability in the detection range F02 of the camera decreases, and when the reliability decreases, the accuracy of the position or speed of an object may decrease or erroneous detection may occur. In addition, F32 represents a region where the reliability in the detection range F03 of the radar decreases, and when the reliability decreases, the accuracy of the position and speed of an object may decrease or erroneous detection may occur. Therefore, the low processing load mode is applied to the region where the reliability is lower than that of the other regions even in the boundary portion of the overlapping region of the detection ranges F02 and F03. The high processing load mode is applied to the region having higher reliability than that of the other regions at the boundary portion of the overlapping region of the detection ranges F02 and F03. At this time, in the low processing load mode, object information of a sensor with high reliability is selected.

By adopting the concept of the reliability of the sensors (external recognition sensors) of the third embodiment, in addition to the effects of the first embodiment, the ratio of integration processing with a high processing load can be further minimized, and the effect of reducing the processing load is improved. In addition, by excluding information from a sensor having low reliability, an effect of preventing erroneous detection of an integration result and a decrease in accuracy is obtained.

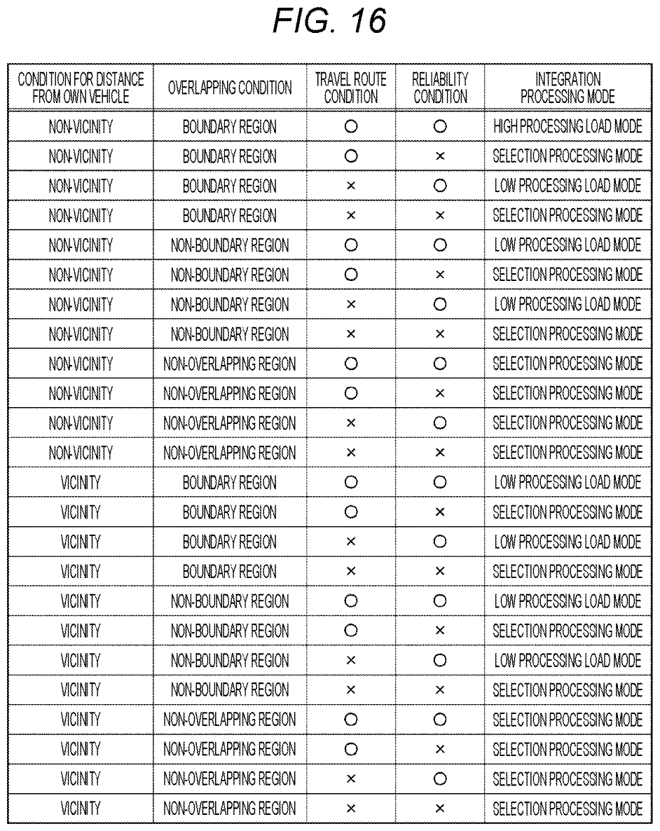

In addition, the first, second, and third embodiments may be combined, and the mode may be switched between the high processing load mode, the low processing load mode, and the selection processing mode based on a combination of the conditions as illustrated in FIG. 16. When a condition for the distance from the own vehicle is non-vicinity, an object indicates an object at a far position, and when the condition for the distance from the own vehicle is vicinity, the object indicates an object at a close position (see the condition of the first embodiment). In addition, when an overlapping condition indicates a boundary region, the condition indicates a boundary portion of an overlapping region of detection ranges, and when the overlapping condition indicates a non-boundary region, the condition indicates a region other than the boundary portion of the overlapping region of the detection ranges. When the overlapping condition is a non-overlapping region, the condition indicates a region in which detection ranges do not overlap (see the condition of the first embodiment). When a travel route condition indicates “∘”, the condition indicates a detection range present on the travel route. When the condition indicates “x”, the condition indicates a detection range not present on the travel route (see the condition of the second embodiment). When a reliability condition indicates “∘”, the condition indicates a region where the reliability of the sensor is high, and when the reliability condition indicates “x”, the condition indicates a region where the reliability of the sensor is low (see the condition of the third embodiment). As illustrated in FIG. 16, the combination of the conditions can further minimize the ratio of integration processing with a high processing load, and the effect of reducing the processing load is improved.

### Fourth Embodiment

In the fourth embodiment, as in the first embodiment, the autonomous driving system configuration of FIG. 1, the functional block diagram of FIG. 3, and the flowcharts of FIGS. 4 to 8 are adopted. However, the determination condition of the integration processing mode determination unit 102 of FIG. 5 is different from that of the first embodiment.

In the fourth embodiment, the integration processing mode 209 is switched (set) based on a tracking state of a predicted object. Here, the tracking state refers to a tracking time at which the predicted object can be continuously tracked without interruption. In a case where the tracking can be performed continuously, the tracking object is given the same tracking ID. In the case of the initial detection in which the tracking time of the predicted object is short, the mode is set to the high processing load mode, and in the case where the tracking time is long to some extent, the mode is switched to the low processing load mode. In addition, the condition may be a case where the tracking time is long and the distance of the object from the own vehicle is long. When it is determined that the existence probability (for example, it is calculated from the tracking time of the predicted object or the like) of the predicted object is low, the low processing load mode is set, and when it is determined that the existence probability of the predicted object is high, the high processing load mode is set. In addition, the mode is switched between the high processing load mode, the low processing load mode, and the selection processing mode according to the existence probability of a sensor object detected by the sensor instead of the predicted object.

By adopting the concept of the tracking state of an object including a predicted object, a sensor object, or the like according to the fourth embodiment, in addition to the effects of the first embodiment, the ratio of integration processing with a high processing load can be further minimized, and the effect of reducing the processing load is improved.

### Fifth Embodiment

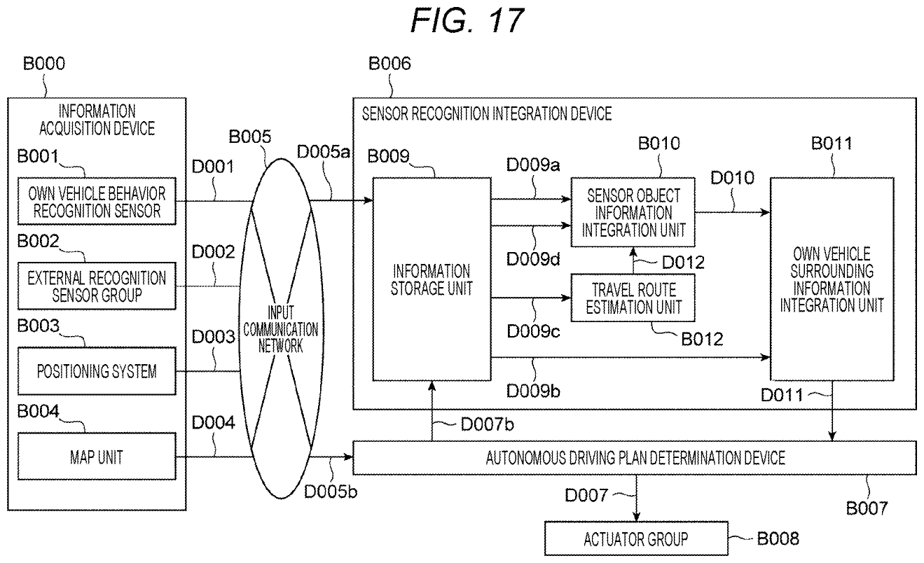

In the fifth embodiment, as in the first embodiment, the functional block diagram of FIG. 3 and the flowcharts of FIGS. 4 to 8 are adopted. However, the autonomous driving system configuration of FIG. 1 and the determination condition of the integration processing mode determination unit 102 illustrated in FIG. 5 are different from those of the first embodiment. FIG. 17 is a configuration diagram of an autonomous driving system including a sensor recognition integration device B006 according to a fifth embodiment of the present invention.

In FIG. 17, signal connection is added to the autonomous driving system configuration of FIG. 13. As for additional portions, a planned path D007b is output from an autonomous driving plan determination device B007 to an information storage unit B009 of the sensor recognition integration device B006. Further, the information storage unit B009 outputs a planned path D009d to the sensor object information integration unit B010.

The planned path refers to a target value of a travel path of an own vehicle planned by the autonomous driving plan determination device B007 based on an integration result D011 during autonomous driving. The planned path is converted into a lane-level planned path by the autonomous driving plan determination device B007 on the basis of navigation information from a map unit B004.

The planned path D009d is replaced with the travel route estimation result D012 of FIG. 13 in the second embodiment, that is, the travel route F22 of FIG. 14, and the integration processing mode determination unit 102 of FIG. 5 switches an integration processing mode.

By adopting the planned path D009d for controlling the vehicle (own vehicle) of the fifth embodiment, in addition to the effects of the first embodiment, the ratio of integration processing with a high processing load can be further minimized, and the effect of reducing the processing load is improved. In addition, the integration processing mode 209 can be switched using the path with higher accuracy than that of the second embodiment, and erroneous mode switching is reduced and accuracy is increased.

### Sixth Embodiment

In the sixth embodiment, as in the first embodiment, the autonomous driving system configuration of FIG. 1, the functional block diagram of FIG. 3, and the flowcharts of FIGS. 4 to 8 are adopted. However, the integration condition of the integration target information generation unit 104 in FIG. 6 is different from that of the first embodiment.

In the sixth embodiment, when the tracking state is stable based on the tracking state of the predicted object, the execution frequency (processing cycle) of the high-load processing mode is decimated, and the low-processing load mode is executed in the decimated processing cycle instead. That is, the processing cycle of the high-load processing mode is made variable on the basis of the tracking state of the predicted object, and when the tracking state is stable, the execution frequency (processing cycle) of the high-load processing mode is set to be long. The stable tracking state includes a case where the object is traveling at a constant speed, a case where the tracking time so far is long, and a case where a situation where an object that is obtained from the sensor and is to be integrated is not repeatedly detected and not detected frequently continues. In addition, the processing cycle of the integration processing mode such as the high processing load mode may be variable according to the tracking state of the sensor object detected by the sensor instead of the predicted object.

By setting the execution cycle of the high-load processing mode of the sixth embodiment to be long, in addition to the effects of the first embodiment, the ratio of the integration processing with a high processing load can be further minimized, and the effect of reducing the processing load is improved. In addition, since it is limited to a case where the tracking state of the object such as the predicted object is stable, an abrupt change in the position of the object can be suppressed by the integration update with the prediction update.

### Seventh Embodiment

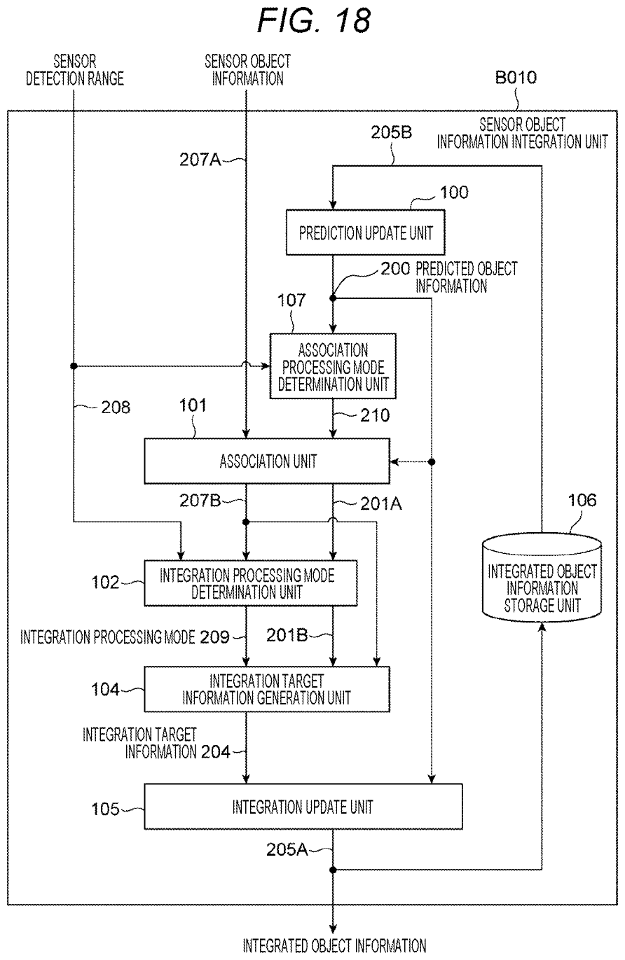

In the seventh embodiment, as in the first to sixth embodiments, the autonomous driving system configuration of FIG. 1, the functional block diagram of FIG. 3, and the flowcharts of FIGS. 4 to 8 are adopted. However, processing of referring to the integration processing mode of the integration processing mode determination unit 102 in FIG. 5 is the association unit 101 in FIG. 4. FIG. 18 is a functional block diagram of a sensor object information integration unit B010 of a sensor recognition integration device B006 according to the seventh embodiment of the present invention.

As illustrated in FIG. 18, an association processing mode determination unit 107 is arranged in the pre-stage processing of the association unit 101. The association processing mode determination unit 107 calculates (switches) an association processing mode 210 referred to by the association unit 101 on the basis of a sensor detection range 208 and information of predicted object information 200 of a prediction update unit 100, and outputs the association processing mode to the association unit 101. Note that a basic idea of the association processing mode determination unit 107 is similar to that of the integration processing mode determination unit 102. Similarly to the first embodiment, when the predicted object information 200 is located in a boundary region in a sensor detection range 208, the association processing mode is set to a high-processing-load association mode. Otherwise, the association processing mode is set to a low-processing-load association mode. In addition, it conforms to the idea of the second to sixth embodiments.

In addition, in the processing of the association unit 101 in FIG. 4, the determination content of the association is switched between the calculation of a high processing load (relatively detailed processing) and the calculation of a low processing load (relatively simple processing) on the basis of the association processing mode 210. Examples of the high processing load include processing of calculating the Mahalanobis distance on the basis of an error covariance in order to calculate the relevance between the predicted object and the object from the sensor. The relevance may be determined from the Euclidean distance with a low processing load. However, in order to maintain the accuracy of the association, in a case where a low processing load is applied, it is preferable to limit to a scene where the effect on the vehicle travel control is small, such as a case where an object is separately far from the own vehicle.

According to the seventh embodiment, similarly to the first embodiment, the ratio of the high-processing-load integration processing can be minimized, and the effect of reducing the processing load is enhanced.

Note that the present invention is not limited to the above-described embodiments and includes various modifications. For example, the above-described embodiments have been described in detail for easy understanding of the present invention, and are not necessarily limited to those having all the described configurations. In addition, a part of the configuration of a certain embodiment can be replaced with the configuration of another embodiment, and the configuration of a certain embodiment can be added to the configuration of another embodiment. In addition, for a part of the configuration of each embodiment, it is possible to add, delete, and replace another configuration.

In addition, some or all of the above-described configurations, functions, processing units, processing means, and the like may be implemented by hardware, for example, by designing with an integrated circuit. In addition, each of the above-described configurations, functions, and the like may be implemented by software by a processor interpreting and executing a program for implementing each function. Information such as a program, a table, and a file for implementing each function can be stored in a storage device such as a memory, a hard disk, and a solid state drive (SSD), or a recording medium such as an IC card, an SD card, and a DVD.

In addition, the control lines and the information lines indicate what is considered to be necessary for the description, and not all the control lines and the information lines on the product are indicated. In practice, it may be considered that almost all the configurations are connected to each other.

### REFERENCE SIGNS LIST

B000 information acquisition device
B001 own vehicle behavior recognition sensor
B002 external recognition sensor group
B003 positioning system
B004 map unit
B005 input communication network
B006 sensor recognition integration device
B007 autonomous driving plan determination device (plan determination unit)
B008 actuator group
B009 information storage unit
B010 sensor object information integration unit
B011 own vehicle surrounding information integration unit
B012 travel route estimation unit (second embodiment)
100 prediction update unit
101 association unit
102 integration processing mode determination unit
104 integration target information generation unit
105 integration update unit
106 integrated object information storage unit
107 association processing mode determination unit (seventh embodiment)

1. A sensor recognition integration device that integrates a plurality of pieces of object information related to an object around an own vehicle detected by a plurality of external recognition sensors, the sensor recognition integration device comprising:
a prediction update unit that generates predicted object information obtained by predicting an action of the object on the basis of an action of the own vehicle estimated from a behavior of the own vehicle and the object information detected by the external recognition sensors;
an association unit that calculates a relationship between the predicted object information and the plurality of pieces of object information;
an integration processing mode determination unit that switches an integration processing mode for determining a method of integrating the plurality of pieces of object information on the basis of a positional relationship between a specific region in an overlapping region of detection regions of the plurality of external recognition sensors and the predicted object information; and
an integration target information generation unit that integrates the plurality of pieces of object information associated with the predicted object information on the basis of the integration processing mode.

2. The sensor recognition integration device according to claim 1, wherein
the specific region is a boundary portion in the overlapping region of the detection regions of the plurality of external recognition sensors.

3. The sensor recognition integration device according to claim 1, wherein
the specific region is the overlapping region of the detection regions of the plurality of external recognition sensors located on a travel route of the own vehicle estimated from a behavior of the own vehicle.

4. The sensor recognition integration device according to claim 1, wherein
the specific region is a region where reliability of the external recognition sensors decreases in the overlapping region of the detection regions of the plurality of external recognition sensors.

5. The sensor recognition integration device according to claim 1, wherein
the integration processing mode includes a first mode in which, when the plurality of pieces of object information belong to the specific region, processing of integrating the plurality of pieces of object information is relatively detailed processing, and a second mode in which, when at least one of the plurality of pieces of object information does not belong to the specific region, processing of integrating the plurality of pieces of object information is relatively simple processing.

6. The sensor recognition integration device according to claim 1, wherein
the integration target information generation unit integrates the plurality of pieces of object information on the basis of the integration processing mode based on an error distribution of each external recognition sensor.

7. The sensor recognition integration device according to claim 1, wherein
the integration processing mode determination unit switches the integration processing mode on the basis of a tracking state of the object.

8. The sensor recognition integration device according to claim 7, wherein
the tracking state of the object is a tracking time of the object.

9. The sensor recognition integration device according to claim 7, wherein
the tracking state of the object is an existence probability of the object.

10. The sensor recognition integration device according to claim 1, wherein
the integrated object information is continuously changed at a time of switching the integration processing mode.

11. The sensor recognition integration device according to claim 1, further comprising
a plan determination unit that plans a planned path for controlling the own vehicle by the integrated object information, wherein
the integration processing mode determination unit switches the integration processing mode on the basis of the planned path.

12. The sensor recognition integration device according to claim 5, wherein
a processing cycle of the detailed processing is made variable based on a tracking state of the object.

13. The sensor recognition integration device according to claim 3, wherein
the integration processing mode is switched according to an effect of the object on the travel route of the own vehicle estimated from the behavior of the own vehicle.

14. The sensor recognition integration device according to claim 1, further comprising an association processing mode determination unit that switches association processing of the object in the association unit between relatively detailed processing and relatively simple processing.

15. The sensor recognition integration device according to claim 1, wherein
the integration processing mode determination unit switches the integration processing mode on the basis of a distance from the own vehicle to the object.
